(19) United States
(12) Patent Application Publication
(10) Pub. No.: US 2010/0098368 A1
(43) Pub. Date: Apr. 22, 2010

(54) ARRANGEMENT FOR AXIALLY SUPPORTING A SHAFT OF A WORK MACHINE

(75) Inventors: August van der Beek, Grevenbroich (DE); Bernhard Kock, Moers (DE); Jochen Weiers, Erkelenz (DE)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Metso Lindemann GmbH

(21) Appl. No.: 12/553,159

(22) Filed: Sep. 3, 2009

(30) Foreign Application Priority Data
Oct. 21, 2008 (DE) 10 2008 052 490.5

(51) Int. Cl. F16C 33/30; F16C 19/24; F16C 19/28; F16C 41/00

(52) U.S. Cl. 384/563

(57) ABSTRACT

The invention relates to an arrangement for axially supporting a shaft of a work machine.

### FIELD OF THE INVENTION

The invention relates to an arrangement for axially supporting a shaft of a work machine.

### BACKGROUND OF THE INVENTION

A work machine of this type may be a comminution machine for domestic waste, bulky items, wood or the like, such as is disclosed in EP 1 575 708 B1. Arranged on a shaft are discs which have cutting teeth which revolve with the shaft and interact with fixed knives extending parallel next to the cutting teeth. The material to be comminuted is comminuted as a result of the cutting action between the cutting teeth and the knives.

During operation of a comminution machine of this type, substantial transverse forces can occur in the region of contact between the stator (knife) and rotor (cutting tooth). In this case, the shaft, with the cutting tools mounted securely thereon, can be pulled/pushed in one direction. This is disadvantageous in several respects: on the one hand, the gap between the stationary knife and rotating cutting tooth should be as constant as possible in order to optimise cutting. On the other hand, substantial forces (and if appropriate moments) act on the shaft bearing arrangement. These, in particular axial, forces can become so great that the bearing, for example a fixed bearing embodied as a rolling bearing, is torn out of its anchoring.

In principle, bearings of this type may be divided into fixed/movable bearings and support bearings. In the case of support bearings, a distinction is drawn between floating bearing arrangements and screwed-down bearing arrangements. In all shaft bearings, one or two bearings must be axially secured in order to be able to accommodate the described axial forces.

Not only in the case described by way of example of a “crusher,” but also in other arrangements for axially supporting a shaft of a work machine, the starting point has in the past been the notion of configuring the bearing arrangement in such a way as to allow even the strongest possibly occurring axial forces or the loads resulting from operation of the machine to be compensated for.

As a consequence, in the prior art, a corresponding axial shaft support arrangement is oversized for normal operation, especially as the greatest possible loading occurs only rarely, if at all. The shaft support arrangement is then usually also very large and expensive.

On the other hand, it must be borne in mind that in the event of the occurrence of axial forces which are greater than the forces calculated for the configuration of the design, the bearing and/or its axial securing elements can become damaged or destroyed. This can cause substantial repair costs. In addition, the machine stops during the repair, leading to a loss of production. Finally, the shaft has to be newly aligned again.

### SUMMARY OF THE INVENTION

The invention leads away from these conventional design rules. The invention is based on the idea to design a bearing arrangement based on the axial forces occurring under normal conditions. If, in addition, disturbances occur, in which increased forces/moments act on the shaft bearing arrangement, the invention provides the following features:

The arrangement according to the invention for axially supporting a shaft of a work machine provides a shaft bearing which is arranged in a bearing housing and has an (one) inner ring and an (one) outer ring. The inner ring is securely connected to the shaft. Rolling bodies extend between the inner ring and the outer ring. The axial support is now provided on the outer ring, by a spring unit which acts in the axial direction of the shaft and is supported by a first end on the outer ring of the shaft bearing. A second end of the spring unit is guided in a separate bearing part. If axial forces now occur which are greater than the forces for which the design is configured, the outer ring of the shaft bearing may be axially displaced. This is partly compensated for by the spring unit. In addition, the spring unit may be embodied in such a way that, in the event of a predetermined maximum force being exceeded, the rotational speed of the shaft is reduced or the shaft drive is completely switched off.

A corresponding regulator/controller can also provide other measures as soon as a deviation from a regulating/standard value is detected.

Instead of a force measurement, a distance measurement or a coupled force/distance measurement can also be carried out in the region of the shaft bearing (of the outer ring) in order to be able to ascertain irregularities in the operating sequence of the work machine in the event of axial displacement of the shaft.

The aforementioned spring unit may in principle be a mechanical spring unit; according to one embodiment, the spring unit comprises a piston/cylinder unit, for example a hydraulically operating piston/cylinder unit. The opposing force or the spring action of the unit can be adjusted by way of the oil pressure. This can be carried out statically or dynamically via corresponding controlling.

While one end of the spring unit rests against the outer ring of the shaft bearing, the spring unit is supported, in accordance with a further embodiment of the invention, at the opposing end on a bearing part, for example an annular body, which is screwed onto the bearing housing of the shaft bearing. This provides guidance of the spring and support unit in a stationary, rigid bearing part which can accommodate axial forces in the event of a shaft displacement, cushioning taking place via the spring unit which is inserted between this bearing part and the outer ring of the shaft bearing.

The bearing housing itself can, in turn, be stationarily mounted.

One embodiment of the invention makes provision for supporting of the outer ring of the shaft bearing—viewed in the axial direction of the shaft—by a stationary securing element on the side opposing the spring unit. This securing element can for example be securely connected to the bearing housing and stand on a machine frame.

The invention may be carried out in different shaft bearings, for example the bearing arrangements such as mentioned above. These include fixed or movable bearings of a rolling bearing. Rolling bearings are constructions elements for transmitting radial and/or axial loads to rotating parts, within the scope of the invention for transmitting radial and/or axial forces of a rotating shaft of a work machine. Insofar the invention embraces all designs of rolling bearings of this type, for example spherical roller bearings and tapered roller bearings.

According to one embodiment, the arrangement according to the invention also includes a control unit which controls an associated shaft drive as a function of forces/moments acting on the spring unit. This ensures that in the event, which is, as mentioned, generally rare, of a particularly high axial load, the corresponding forces/moments can rapidly be detected in order then to be able, for example, to immediately switch off the shaft drive and to prevent damage to the work machine. In the next step, the disturbance can be eliminated and the machine started up again as normal.

The inventive concept has the advantage that the oversizing provided in prior art, based on regulatory operation, may be dispensed with. The arrangement is constructed in such a way that forces/moments differing from regulatory operation may within certain limits be compensated for by the spring unit; more extensive forces/moments are detected and processed in terms of controlling in that the device is, for example, switched off for repair work.

Further features of the invention emerge from the features of the sub-claims and the other application documents.

### BRIEF DESCRIPTION OF THE DRAWING

The invention will be described hereinafter in greater detail based on an exemplary embodiment.

FIG. 1 shows a vertical section through an arrangement according to the invention for axially supporting a shaft 10 of a comminution device according to EP 1 575 708 B1.

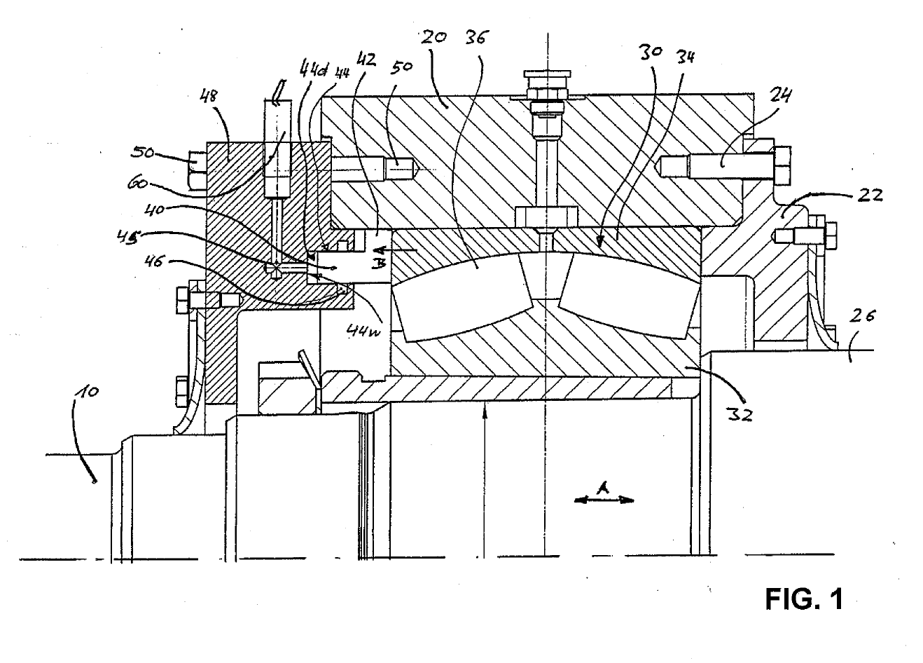

### DETAILED DESCRIPTION OF PREFERRED EMBODIMENT

The figure shows a shaft bearing 30 arranged in a bearing housing 20. The shaft bearing 30 is in this case a fixed/movable bearing in the form of a rolling bearing and comprises one inner ring 32, one outer ring 34 and rolling bodies arranged therebetween (spherical rollers) 36.

While the inner ring 32 rests securely on the shaft 10 and rotates therewith, the outer ring 34 is fastened to the bearing housing 20. The bearing housing 20 is secured to a machine frame/machine housing 26 of the work machine by screws 24 via a bearing cover 22.

If a disturbance occurs in the region of the work machine, this can lead to a displacement of the shaft 10 in the axial direction (arrow A) and thus to a displacement of the outer ring 34 in arrow direction B. For supporting the outer ring 34, the arrangement according to the invention provides a spring and support unit 40 which is in this case embodied as follows.

An annular body 48 is fastened to the bearing housing 20 via screws 50. In the annular body 48, an annular groove 44, into which an annular piston 40 is inserted, extends on the portion opposing the outer ring 34. A ring seal 46 serves to produce a seal between the annular body 48 and the annular piston 40 guided therein. A pressure chamber 44d, into which a line 45 for hydraulic oil opens, is formed between the end of the annular piston 40 that is on the left-hand side in the figure and the opposing wall 44w of the annular groove 44. The axial supporting force, acting on the annular piston 40, and provided for the outer ring 34 of the rolling bearing can be adjusted by way of the oil pressure. The further connections of the hydraulic line 45, such as the oil pump, manometer, seals, etc., are, like an associated regulating unit, illustrated only schematically by 60.

The illustrated piston/cylinder unit compensates for axial displacement of the outer ring 34 in arrow direction B up to a certain degree. In the event of greater axial forces and thus greater axial displacement (beyond a maximum value which can be set in advance), this is measured by way of the oil pressure, recorded and implemented in terms of control in such a way that a shaft drive (not shown) is immediately switched off.

This eliminates the need to provide oversized support bearings for the shaft bearing arrangement in order to prevent destruction of the system even in the rare case of operational disturbance with superproportional axial forces acting on the shaft.

In a fixed/movable bearing arrangement, on the fixed bearing side, both bearing covers can be replaced by an arrangement according to the invention. If, as in an aforementioned crusher, high forces occur only in one direction, one spring unit on one side will be sufficient (as shown).

In an O-shaped bearing arrangement, X-shaped bearing arrangement, etc., only one side is generally embodied in the manner according to the invention.

1. Arrangement for axially supporting a shaft of a work machine having the following features:
1.1 a shaft bearing which is arranged in a bearing housing and provides an inner ring and an outer ring,
1.2 a spring unit which acts in the axial direction of the shaft and is supported by a first end on the outer ring of the shaft bearing and guided by a second end in a separate bearing part.

2. Arrangement according to claim 1, the spring unit of which comprises a piston/cylinder unit.

3. Arrangement according to claim 1, the spring unit of which comprises a hydraulically operating piston/cylinder unit.

4. Arrangement according to claim 1, the bearing part of which is an annular body.

5. Arrangement according to claim 1, the bearing part of which is screwed onto the bearing housing.

6. Arrangement according to claim 1, the bearing housing of which is stationarily mounted.

7. Arrangement according to claim 1, the shaft bearing of which is a fixed/movable bearing of a rolling bearing.

8. Arrangement according to claim 1, wherein the outer ring of the shaft bearing rests—viewed in the axial direction of the shaft—against a stationary securing element on a side opposing the spring unit.

9. Arrangement according to claim 8, the securing element of which is securely connected to the bearing housing.

10. Arrangement according to claim 4, with an annular piston which is guided in the annular body and can be acted on by means of hydraulic oil which can be conveyed to a pressure chamber via a line.

11. Arrangement according to claim 1, with a regulating unit which controls an associated shaft drive as a function of forces acting on the spring unit.
